(19) United States
(12) Patent Application Publication
(10) Pub. No.: US 2025/0166941 A1
(43) Pub. Date: May 22, 2025

(54) LIGHTING KEYBOARD AND BACKLIGHT MODULE

(71) Applicant: DARFON ELECTRONICS CORP., Taoyuan City (TW)

(72) Inventors: Hsin-Hung Liu, Taoyuan City (TW); Wen-Ming Hsu, Taoyuan City (TW); Heng-Yi Huang, Taoyuan City (TW)

(73) Assignee: DARFON ELECTRONICS CORP., Taoyuan City (TW)

(21) Appl. No.: 18/942,760

(22) Filed: Nov. 10, 2024

Related U.S. Application Data
(60) Provisional application No. 63/600,729, filed on Nov. 19, 2023.

(30) Foreign Application Priority Data
Sep. 27, 2024 (TW) 113210504

(51) Int. Cl. H01H 13/02; H01H 13/04; H01H 13/10; H01H 13/7057

(52) U.S. Cl. CPC H01H 13/023; H01H 13/04; H01H 13/10; H01H 13/7057

(57) ABSTRACT

A lighting keyboard includes a plurality of keys and a backlight module. Each of the keys has a keycap. The backlight module is located below the keys. The backlight module includes a plurality of light emitting units and a light guide plate. Three of the light emitting units are arranged in a triangle to form a light emitting area. The light emitting area overlaps with at least two keycaps. The light guide plate is provided with two relatively sparser microstructure regions and at least one relatively denser microstructure region on a connection line of at least two of the three light emitting units. The two relatively sparser microstructure regions are respectively close to the at least two light emitting units. The at least one relatively denser microstructure region is located between the two relatively sparser microstructure regions.

### CROSS REFERENCE TO RELATED APPLICATION

This application claims the benefit of U.S. Provisional Application No. 63/600,729, filed on Nov. 19, 2023. The content of the application is incorporated herein by reference.

### BACKGROUND OF THE INVENTION

### 1. Field of the Invention

The invention relates to a lighting keyboard and a backlight module and, more particularly, to a lighting keyboard and a backlight module capable of reducing the number of light emitting units to reduce power consumption.

### 2. Description of the Prior Art

As technology advances, there are many types of keyboards in use. Users pay much more attention to visual effect of keyboard except basic input function while choosing keyboard. So far a lighting keyboard has been developed. The lighting keyboard attracts users in visual effect and can be used in darkness. The lighting keyboard of the prior art disposes at least one light emitting diode below each key correspondingly. Excessive number of light emitting diodes will increase power consumption and manufacturing cost.

### SUMMARY OF THE INVENTION

The invention provides a lighting keyboard and a backlight module capable of reducing the number of light emitting units to reduce power consumption, so as to solve the aforesaid problems.

According to an embodiment of the invention, a lighting keyboard comprises a plurality of keys and a backlight module. Each of the plurality of keys has a keycap. The backlight module is located below the plurality of keys. The backlight module comprises a plurality of light emitting units. Three of the plurality of light emitting units are arranged in a triangle to form a light emitting area. The light emitting area overlaps with at least two keycaps.

According to another embodiment of the invention, a lighting keyboard comprises a plurality of keys and a backlight module. The backlight module is located below the plurality of keys. The backlight module comprises a plurality of light emitting units and a light guide plate. Three of the plurality of light emitting units are arranged in a triangle. The light guide plate is provided with two relatively sparser microstructure regions and at least one relatively denser microstructure region on a connection line of at least two of the three light emitting units. The two relatively sparser microstructure regions are respectively close to the at least two light emitting units. The at least one relatively denser microstructure region is located between the two relatively sparser microstructure regions.

According to another embodiment of the invention, a backlight module comprises a plurality of light emitting units and a light guide plate. Three of the plurality of light emitting units are arranged in a triangle. The light guide plate is provided with two relatively sparser microstructure regions and at least one relatively denser microstructure region on a connection line of at least two of the three light emitting units. The two relatively sparser microstructure regions are respectively close to the at least two light emitting units. The at least one relatively denser microstructure region is located between the two relatively sparser microstructure regions.

As mentioned in the above, the invention uses three light emitting units as one unit and arranges the three light emitting units in a triangle, wherein the light emitting area formed by the three light emitting units may overlap with at least two keycaps. Accordingly, the number of light emitting units can be effectively reduced to reduce power consumption and manufacturing cost. Furthermore, the light guide plate is provided with two relatively sparser microstructure regions and at least one relatively denser microstructure region on the connection line of at least two of the three light emitting units, wherein the at least one relatively denser microstructure region is located between the two relatively sparser microstructure regions. Through the arrangement of the relatively denser microstructure region and the relatively sparser microstructure region, highly uniform luminescence can be achieved in a single key and the entire keyboard.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating a lighting keyboard according to an embodiment of the invention.

FIG. 2 is a partial schematic view illustrating the lighting keyboard shown in FIG. 1.

FIG. 3 is a schematic view illustrating the light emitting unit according to an embodiment of the invention.

FIG. 4 is a schematic view illustrating the light emitting unit according to another embodiment of the invention.

FIG. 5 is a partial schematic view illustrating a lighting keyboard according to another embodiment of the invention.

### DETAILED DESCRIPTION

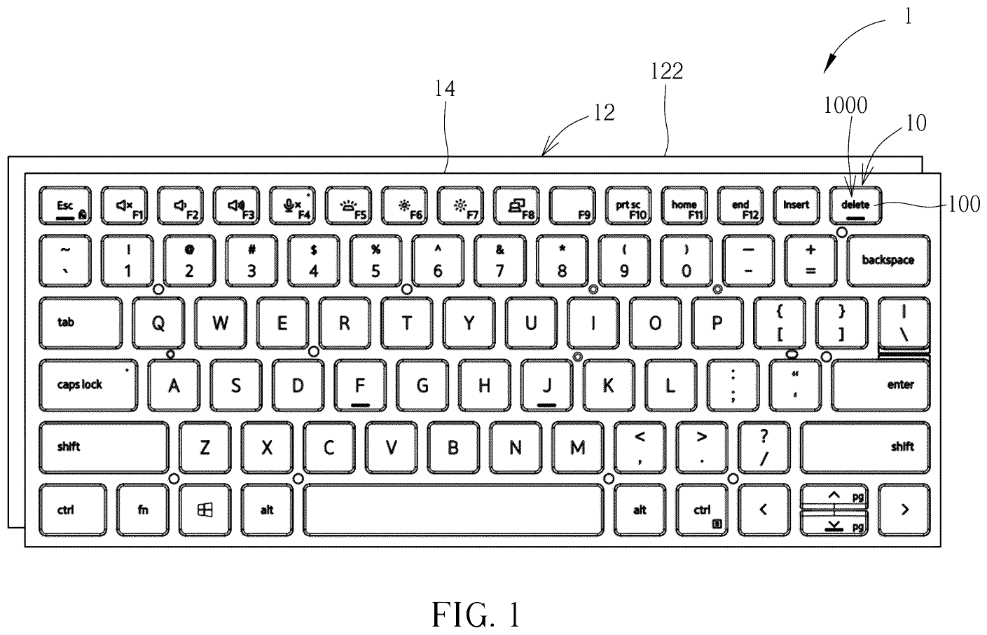

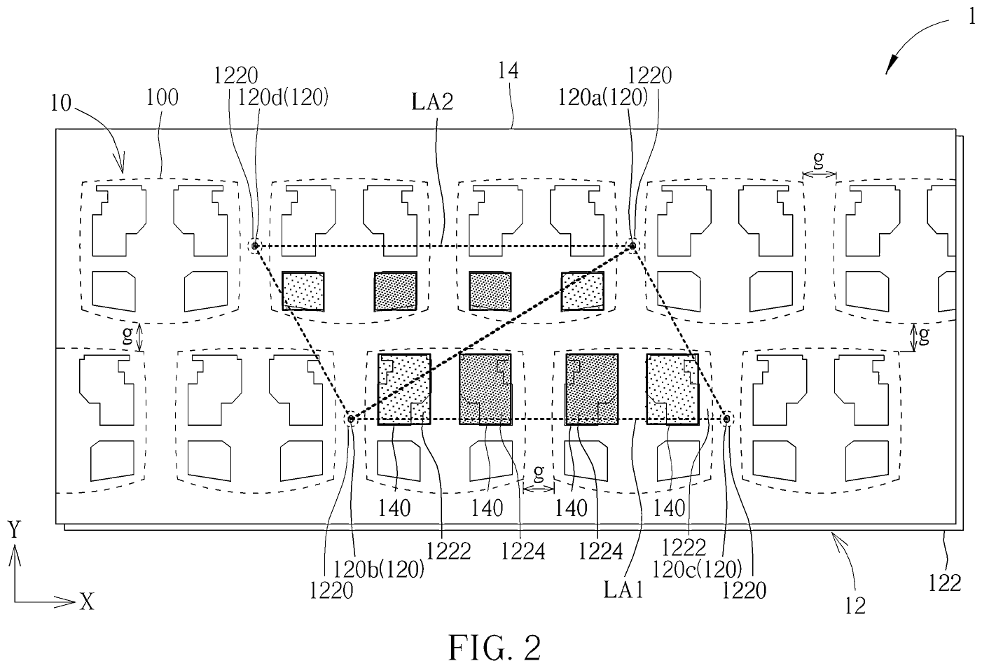

Referring to FIGS. 1 and 2, FIG. 1 is a schematic view illustrating a lighting keyboard 1 according to an embodiment of the invention and FIG. 2 is a partial schematic view illustrating the lighting keyboard 1 shown in FIG. 1.

As shown in FIGS. 1 and 2, the lighting keyboard 1 comprises a plurality of keys 10, a backlight module 12 and a support plate 14. The backlight module 12 is located below the plurality of keys 10, and the support plate 14 is located between the plurality of keys 10 and the backlight module 12. For further explanation, the plurality of keys 10 are disposed on the support plate 14 and the support plate 14 is disposed on the backlight module 12. In this embodiment, two adjacent keys 10 in a longitudinal direction Y of the lighting keyboard 1 may be misaligned in a lateral direction X of the lighting keyboard 1. Each of the keys 10 has a keycap 100. In practical applications, each of the keys 10 may further have a support mechanism and a restoration member (not shown). The support mechanism is disposed between the keycap 100 and the support plate 14. When the keycap 100 is pressed, the keycap 100 will move vertically toward the support plate 14 along with the support mechanism. The restoration member is disposed between the keycap 100 and the support plate 14, wherein the restoration member may be, but is not limited to, a rubber dome. Furthermore, a circuit board (not shown) may be disposed on the support plate 14. The circuit board may have a switch (e.g. membrane switch or other trigger switches) corresponding to the key 10.

In this embodiment, the keycap 100 may have a light transmissive area 1000 and the support plate 14 may have a plurality of plate holes 140, wherein the positions of the plate holes 140 of the support plate 14 correspond to the position of the light transmissive area 1000 of the keycap 100. The light transmissive area 1000 is surrounded by an opaque area. It should be noted that the number of light transmissive areas 1000 and plate holes 140 may be determined according to practical applications, so the invention is not limited to the embodiment shown in the figure. The light emitted by the backlight module 12 may be projected from the light transmissive area 1000 of the keycap 100 through the plate holes 140 of the support plate 14, so as to form an illuminated pattern corresponding to the light transmissive area 1000.

In this embodiment, the backlight module 12 may comprise a plurality of light emitting units 120 and a light guide plate 122. The light guide plate 122 may have a plurality of accommodation holes 1220 configured to respectively accommodate the plurality of light emitting units 120. The light emitting units 120 may be a five-side or single-side light emitting diode according to practical applications. Three of the plurality of light emitting units 120 are arranged in a triangle to form a light emitting area, wherein the light emitting area overlaps with at least two keycaps 100. As shown in FIG. 2, three light emitting units 120a, 120b, 120c are arranged in a triangle to form a light emitting area LA1, and the light emitting area LA1 overlaps with four keycaps 100; three light emitting units 120a, 120b, 120d are arranged in a triangle to form a light emitting area LA2, and the light emitting area LA2 overlaps with four keycaps 100. For further explanation, the invention uses three light emitting units 120 as one unit and arranges the three light emitting units 120 in a triangle, such that the light emitting area formed by every three light emitting units 120 may provide light for at least two keycaps 100. Accordingly, the number of light emitting units 120 can be effectively reduced to reduce power consumption and manufacturing cost.

In the following, the three light emitting units 120a, 120b, 120c shown in FIG. 2 will be used to illustrate other technical features of the invention.

As shown in FIG. 2, a connection line of at least two of the three light emitting units 120a, 120b, 120c may overlap with at least two keycaps 100. In this embodiment, the connection line of two light emitting units 120a, 120b may overlap with two keycaps 100, the connection line of two light emitting units 120a, 120c may overlap with two keycaps 100, and the connection line of two light emitting units 120b, 120c may overlap with two keycaps 100. However, the invention is not so limited. The connection line of two light emitting units may also overlap with more than two keycaps 100 according to practical applications. Furthermore, at least one of the three light emitting units 120a, 120b, 120c may overlap with a gap g between two adjacent keys 10. In this embodiment, each of the three light emitting units 120a, 120b, 120c overlaps with the gap g between two adjacent keys 10, but the invention is not so limited. At least one of the three light emitting units 120a, 120b, 120c may also overlap with the keycap 100 of the key 10 according to practical applications.

In this embodiment, the light guide plate 122 is provided with two relatively sparser microstructure regions and at least one relatively denser microstructure region on a connection line of at least two of the three light emitting units 120a, 120b, 120c, wherein the two relatively sparser microstructure regions are respectively close to the at least two light emitting units, and the at least one relatively denser microstructure region is located between the two relatively sparser microstructure regions. As shown in FIG. 2, the light guide plate 122 may be provided with two relatively sparser microstructure regions 1222 and two relatively denser microstructure regions 1224 on the connection line of two light emitting units 120b, 120c, wherein the two relatively sparser microstructure regions 1222 are respectively close to the two light emitting units 120b, 120c, and the two relatively denser microstructure regions 1224 are located between the two relatively sparser microstructure regions 1222. In other words, the relatively sparser microstructure regions 1222 are closer to the light emitting units 120b, 120c whereas the relatively denser microstructure regions 1224 are farther away from the light emitting units 120b, 120c. The relatively sparser microstructure region 1222 may be configured with scattering structures with a lower distribution density, and the relatively denser microstructure region 1224 may be configured with scattering structures with a higher distribution density, wherein the scattering structures may be dot-pattern and/or line-pattern according to practical applications. Thus, compared to the relatively sparser microstructure region 1222 closer to the light emitting units 120b, 120c, the relatively denser microstructure regions 1224 farther away from the light emitting units 120b, 120c may guide more light to emit upward. Through the arrangement of the relatively denser microstructure region 1224 and the relatively sparser microstructure region 1222, highly uniform luminescence can be achieved in a single key 10 and the entire keyboard 1. It should be noted that the shape and density of relatively sparser microstructure region 1222 and relatively denser microstructure region 1224 may be adjusted according to practical applications, so the invention is not limited to the embodiment shown in the figure.

In this embodiment, the plate holes 140 of the support plate 14 may overlap with the relatively sparser microstructure regions 1222 and the relatively denser microstructure regions 1224. Accordingly, the relatively sparser microstructure regions 1222 and the relatively denser microstructure regions 1224 may guide the light transmitted in the light guide plate 122 to emit upward through the plate holes 140 of the support plate 14. It should be noted that the areas of the relatively sparser microstructure regions 1222 and the relatively denser microstructure regions 1224 may be larger than, equal to, or smaller than the areas of the plate holes 140 according to practical applications.

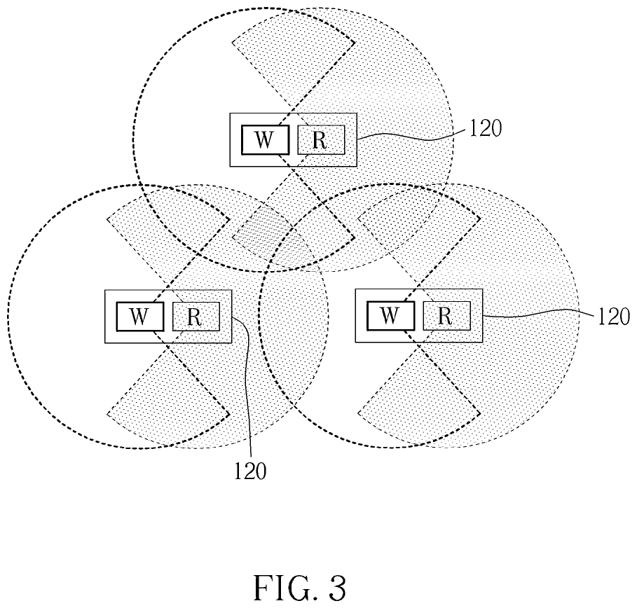

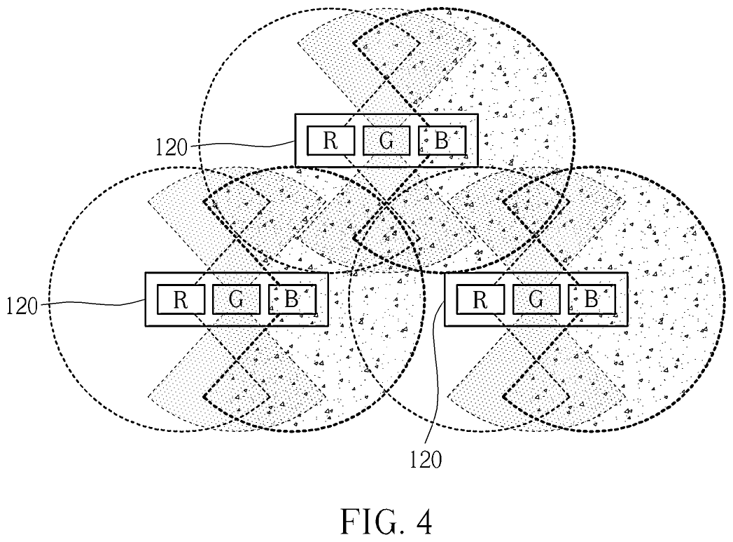

Referring to FIGS. 3 and 4, FIG. 3 is a schematic view illustrating the light emitting unit 120 according to an embodiment of the invention and FIG. 4 is a schematic view illustrating the light emitting unit 120 according to another embodiment of the invention.

In this embodiment, each of the light emitting units 120 may comprise a plurality of dies, wherein the dies are arranged consecutively with short side to short side, and long sides of the dies are arranged consecutively along a length direction of the light emitting unit. As shown in FIG. 3, each of the light emitting units 120 may comprise two dies R, W, wherein the two dies R, W may provide two colors of light (e.g. red light and white light). The two dies R, W are arranged consecutively with short side to short side, and the long sides of the two dies R, W are arranged consecutively along the length direction of the light emitting unit 120, so as to achieve good light mixing effect. As shown in FIG. 4, each of the light emitting units 120 may comprise three dies R, G, B, wherein the three dies R, G, B may provide three colors of light (e.g. red light, green light and blue light). The three dies R, G, B are arranged consecutively with short side to short side, and the long sides of the three dies R, G, B are arranged consecutively along the length direction of the light emitting unit 120, so as to achieve good light mixing effect.

Furthermore, different color dies of any two of the three light emitting units 120 are arranged close to each other, so as to make the light mixing effect of adjacent keys more uniform. As shown in FIG. 3, different color dies R, W of any two of the three light emitting units 120 are arranged close to each other. As shown in FIG. 4, different color dies R, B of any two of the three light emitting units 120 are arranged close to each other.

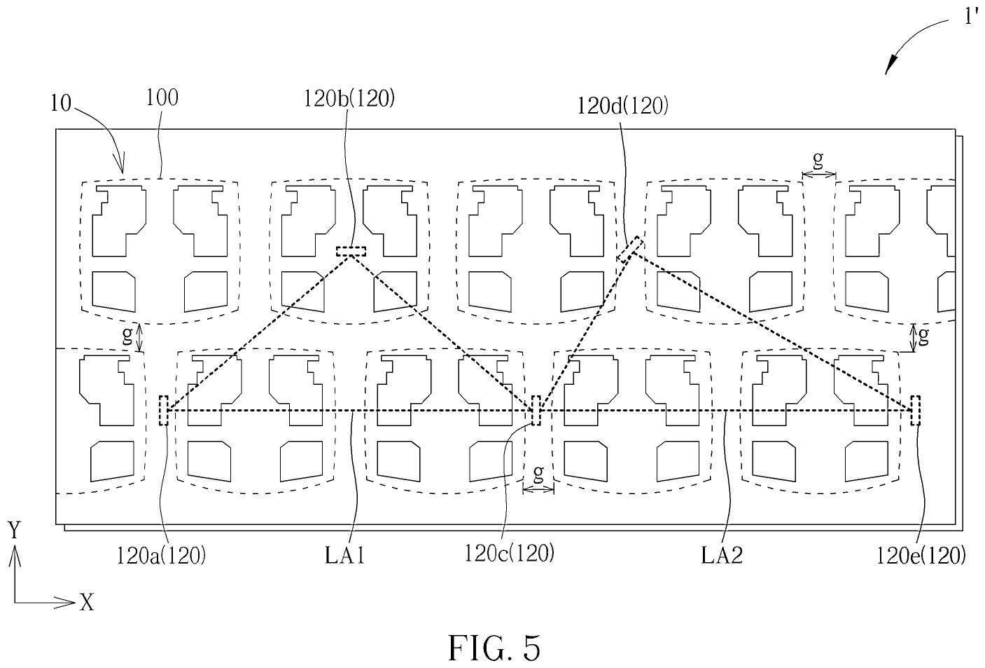

Referring to FIG. 5, FIG. 5 is a partial schematic view illustrating a lighting keyboard 1′ according to another embodiment of the invention.

As shown in FIG. 5, in the lighting keyboard 1′, three light emitting units 120a, 120b, 120c are arranged in a triangle to form a light emitting area LA1, and three light emitting units 120c, 120d, 120e are arranged in a triangle to form a light emitting area LA2. In this embodiment, each of the light emitting units 120a, 120c, 120d, 120e may overlap with the gap g between two adjacent keys 10, and the light emitting unit 120b may overlap with the keycap 100 of the key 10 (i.e. the light emitting unit 120b may be located below the keycap 100 of the key 10). In this embodiment, the long sides of the light emitting units 120a, 120c, 120e may be parallel to the longitudinal direction Y of the lighting keyboard 1′, and the long side of the light emitting unit 120b may be parallel to the lateral direction X of the lighting keyboard 1′. In addition, one of the three light emitting units 120c, 120d, 120e may be arranged obliquely with respect to the other two of the three light emitting units 120c, 120d, 120e. In this embodiment, the light emitting unit 120d may be arranged obliquely with respect to the light emitting units 120c, 120e. The invention may adjust the position and orientation of the light emitting unit according to practical lighting requirements.

As mentioned in the above, the invention uses three light emitting units as one unit and arranges the three light emitting units in a triangle, wherein the light emitting area formed by the three light emitting units may overlap with at least two keycaps. Accordingly, the number of light emitting units can be effectively reduced to reduce power consumption and manufacturing cost. Furthermore, the light guide plate is provided with two relatively sparser microstructure regions and at least one relatively denser microstructure region on the connection line of at least two of the three light emitting units, wherein the at least one relatively denser microstructure region is located between the two relatively sparser microstructure regions. Through the arrangement of the relatively denser microstructure region and the relatively sparser microstructure region, highly uniform luminescence can be achieved in a single key and the entire keyboard.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lighting keyboard comprising:
a plurality of keys, each of the plurality of keys having a keycap; and
a backlight module located below the plurality of keys, the backlight module comprising a plurality of light emitting units, three of the plurality of light emitting units being arranged in a triangle to form a light emitting area, the light emitting area overlapping with at least two keycaps.

2. The lighting keyboard of claim 1, wherein a connection line of at least two of the three light emitting units overlaps with at least two keycaps.

3. The lighting keyboard of claim 1, wherein at least one of the three light emitting units overlaps with a gap between two adjacent keys.

4. The lighting keyboard of claim 1, wherein the backlight module further comprises a light guide plate, the light guide plate is provided with two relatively sparser microstructure regions and at least one relatively denser microstructure region on a connection line of at least two of the three light emitting units, the two relatively sparser microstructure regions are respectively close to the at least two light emitting units, and the at least one relatively denser microstructure region is located between the two relatively sparser microstructure regions.

5. The lighting keyboard of claim 4, further comprising a support plate located between the plurality of keys and the backlight module, wherein the support plate has a plurality of plate holes overlapping with the two relatively sparser microstructure regions and the at least one relatively denser microstructure region.

6. The lighting keyboard of claim 1, wherein each of the plurality of light emitting units comprises a plurality of dies arranged consecutively with short side to short side.

7. The lighting keyboard of claim 1, wherein each of the plurality of light emitting units comprises a plurality of dies, and long sides of the plurality of dies are arranged consecutively along a length direction of the light emitting unit.

8. The lighting keyboard of claim 1, wherein one of the three light emitting units is arranged obliquely with respect to the other two of the three light emitting units.

9. The lighting keyboard of claim 1, wherein different color dies of any two of the three light emitting units are arranged close to each other.

10. The lighting keyboard of claim 1, wherein two adjacent keys in a longitudinal direction of the lighting keyboard are misaligned in a lateral direction of the lighting keyboard.

11. A lighting keyboard comprising:
a plurality of keys; and
a backlight module located below the plurality of keys, the backlight module comprising a plurality of light emitting units and a light guide plate, three of the plurality of light emitting units being arranged in a triangle, the light guide plate being provided with two relatively sparser microstructure regions and at least one relatively denser microstructure region on a connection line of at least two of the three light emitting units, the two relatively sparser microstructure regions being respectively close to the at least two light emitting units, the at least one relatively denser microstructure region being located between the two relatively sparser microstructure regions.

12. The lighting keyboard of claim 11, wherein each of the plurality of keys has a keycap, and a connection line of at least two of the three light emitting units overlaps with at least two keycaps.

13. The lighting keyboard of claim 11, wherein at least one of the three light emitting units overlaps with a gap between two adjacent keys.

14. The lighting keyboard of claim 11, further comprising a support plate located between the plurality of keys and the backlight module, wherein the support plate has a plurality of plate holes overlapping with the two relatively sparser microstructure regions and the at least one relatively denser microstructure region.

15. The lighting keyboard of claim 11, wherein each of the plurality of light emitting units comprises a plurality of dies arranged consecutively with short side to short side.

16. The lighting keyboard of claim 11, wherein each of the plurality of light emitting units comprises a plurality of dies, and long sides of the plurality of dies are arranged consecutively along a length direction of the light emitting unit.

17. The lighting keyboard of claim 11, wherein one of the three light emitting units is arranged obliquely with respect to the other two of the three light emitting units.

18. The lighting keyboard of claim 11, wherein different color dies of any two of the three light emitting units are arranged close to each other.

19. The lighting keyboard of claim 11, wherein two adjacent keys in a longitudinal direction of the lighting keyboard are misaligned in a lateral direction of the lighting keyboard.

20. A backlight module comprising:
a plurality of light emitting units, three of the plurality of light emitting units being arranged in a triangle; and
a light guide plate, the light guide plate being provided with two relatively sparser microstructure regions and at least one relatively denser microstructure region on a connection line of at least two of the three light emitting units, the two relatively sparser microstructure regions being respectively close to the at least two light emitting units, the at least one relatively denser microstructure region being located between the two relatively sparser microstructure regions.
